(19) United States
(12) Patent Application Publication
(10) Pub. No.: US 2004/0005401 A1
(43) Pub. Date: Jan. 8, 2004

(54) Method for applying a washcoat to suppport bodies

(76) Inventor: Robert Becker, Wayne, PA (US)

Correspondence Address: SMITH MOORE LLP, P.O. BOX 21927, GREENSBORO, NC, 27420, US

(21) Appl. No.: 10/190,938

(22) Filed: Jul. 5, 2002

(51) Int. Cl. B05D 1/00

(52) U.S. Cl. 427/8

(57) ABSTRACT

A method for applying washcoat dispersion to catalytic converter support bodies. The temperature of the washcoat dispersion and the temperature of the support body are controlled during the coating process. Preferably, the temperatures are substantially equal. The generally equal temperature results in an equal flow behavior of the washcoat dispersion and therefore results in a generally uniform depth of coating layers. Further, such a small temperature tolerance increases the consistency of the quality of the washcoat coating with regards to mass production of support bodies because the viscosity behavior of the washcoat dispersion is highly predictable.

### BACKGROUND OF THE INVENTION

The present invention relates generally to catalytic converters used in combustion engine emission control, and more particularly, to a method for coating the honeycomb structure of a catalytic converter support body with a washcoat dispersion.

Catalytic converter support bodies generally have a honeycomb structure offering a large enough surface to exchange exhaust fumes flowing through the support bodies with high efficiency. The exhaust fumes may include harmful chemicals such as nitrogen oxide, unsaturated hydrocarbon, and carbon monoxide. The support bodies may be formed with variations of metal foils, where the metal foils, at least partially, have a structure enabling them to develop flow channels by means of a stock and/or wrap procedure. Alternatively, the support bodies may be formed from a ceramic material, such as cordierite and/or aluminum oxide. Extruded support bodies are primarily made from cordierite where kaolin, aluminum hydroxide, aluminum oxide, talc, particles of carbon, etc. are added to the basic material.

Even though the flow channels in the honeycomb structure of the support body preferably have a large enough surface area to exchange harmful fumes, the support bodies are treated with a coating having a craggy surface. Normally, the craggy surface lifts catalysts such as platinum or rhodium, and thereby causes a further mixing of the exhaust fumes that flow through the support body because of the extremely intensive contact of the catalysts with the exhaust fumes.

Washcoat is normally used for support body coatings including aluminum oxide of the transitional series and at least one promotor oxide (rare earth oxides such as nickel oxide, germanium oxide, zircon oxide). Generally, the washcoat is already on the support body before the application of a liquid medium with adequate flow characteristics to achieve a uniform thickness of the layer. The flow characteristics are mainly influenced by the adjusted pH-number of the washcoat dispersion. However, tests have shown that during the coating of these support bodies, a variety of drying or setting behaviors of the washcoat dispersion occur. Particularly, a washcoat dispersion has a time and temperature dependable viscosity, which means that the washcoat dispersion has different flow behaviors during longer coating procedures or due to certain temperatures. Up until now, only washcoat dispersions with select dispersion temperatures were normally provided. The support bodies were provided by the warehouse and treated with the washcoat dispersion. Different support body warehouse locations meant that there were different support body temperatures. The result was that the support bodies, after the application of the washcoat dispersion, showed different and undesirable depths of layers due to the temperature distribution within the support body creating different washcoat dispersion distribution characteristics. Further, large undesirable variations occurred in connection with the quality of the support bodies coated with washcoat depending on the outside temperatures of the production site, as the support bodies were normally stored in unheated warehouses. For example, the support bodies coated during the winter months showed a different quality than the support bodies coated during the summer.

Accordingly, there is a need in the art for a method for coating support bodies with a washcoat that provides a generally uniform thickness of the washcoat layer throughout the length of the support body flow channels. There is a further need in the art for a method for coating support bodies with a washcoat that eliminates the premature decrease of viscosity of the coating due to temperature differences between the support bodies and the washcoat dispersion. In addition, there is a need in the art for a method for coating support bodies with a washcoat that provides consistency in the quality of the support bodies.

### SUMMARY OF THE INVENTION

The method of applying a washcoat dispersion coating onto a support body of the present invention comprises the steps of controlling the temperature of the support body, controlling the temperature of the washcoat dispersion coating, and applying the washcoat dispersion coating to the support body while controlling the temperature of the support body and controlling the temperature of the washcoat dispersion. The method further comprises the steps of drying, impregnating, calcificating, and storing the support body while controlling the temperature of the support body and controlling the temperature of the washcoat dispersion.

Preferably, the difference between the temperature of the support body and the temperature of the washcoat dispersion is no greater than 10° K., and more preferably, no greater than 10° K. It is most preferred that the temperatures are substantially equal. The desired temperatures for the support body and washcoat dispersion may be set so that after ascertaining the temperatures of the support body and the dispersion while applying the washcoat, the temperatures may be adjusted to the desired temperatures.

### BRIEF DESCRIPTION OF THE DRAWINGS

Further objects and advantages of the invention will appear from the following description taken together with the following drawings, in which:

FIG. 1 is a perspective view of a support body in accordance with the present invention.

FIG. 2 is a cross sectional view of the support body of FIG. 1 with a washcoat.

### DESCRIPTION OF THE PREFERRED EMBODIMENT

The illustrations and examples discussed in the following description are provided for the purpose of describing the preferred embodiments of the invention and are not intended to limit the invention thereto.

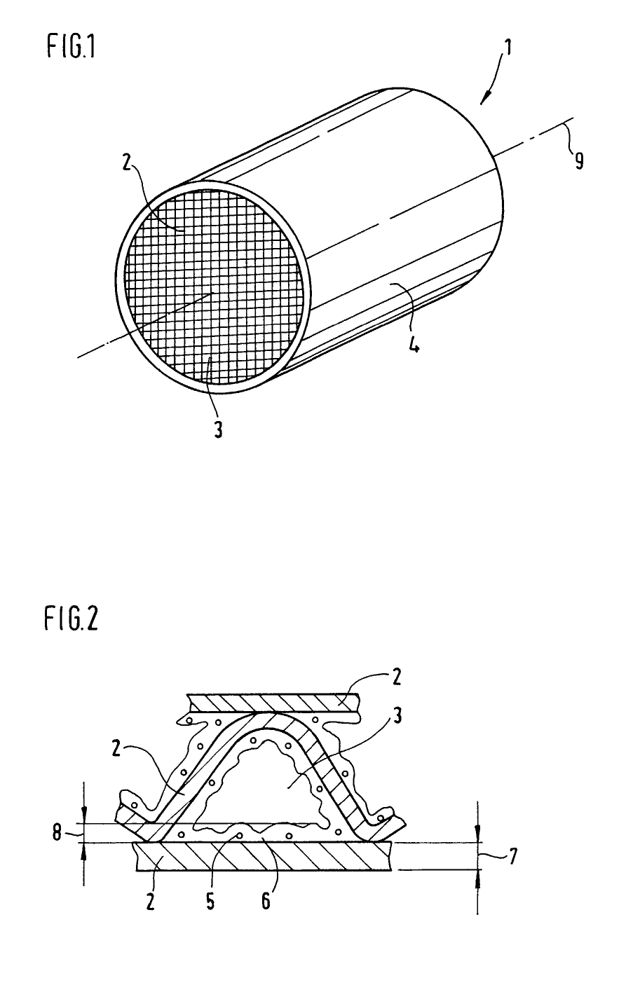

The present invention provides a method for coating a catalytic converter support body with a washcoat dispersion. As shown in FIG. 1, a support body 1 includes a plurality of flow channels 3 which are developed by partitions 2. The flow channels 3 extend mainly parallel to the longitudinal axis 9 of the support body 1. In order to increase the integrity and stability of the support body 1 under high thermal and dynamic pressure, the support body 1 is coated with a washcoat dispersion.

The washcoat dispersion, acting as a solid substance, comprises an especially watery liquid dispersion of one or more temperature-stable support materials such as aluminum oxide or, if necessary, one or more additional solid substances, and/or one or more dissolved compounds as promoters such as rare earth oxides and/or active components such as platinum. The solid substances of the washcoat dispersion show a multiple modal distribution of the core sizes with different core fractions providing fine and coarse solid substances in an active form on the upper surface.

The washcoat dispersion is normally applied to the support body 1 by means of a spray or submerging procedure. If the spray procedure is used, the washcoat dispersion is finely sprayed and inserted above the openings of the flow channels 3 of the support body 1. During the submerging procedure, the support body 1 is, at least partially, submerged into a container including washcoat dispersion. Therefore, a relatively uniform distribution of the washcoat dispersion occurs. If an adequate cross section of the flow channel openings 3 of the support body 1 exists, the washcoat dispersion is sucked into the inner part of the flow channels 3 by a capillary effect.

Generally, the support body 1 has a specific support body temperature and the washcoat dispersion has a predetermined dispersion temperature. However, in a preferred embodiment of the present invention, the temperatures of the support body 1 and the washcoat dispersion are coordinated with regards to the characteristics of the washcoat coating to be achieved, thereby providing a uniform coating layer on the support body. These temperatures are controlled and maintained during the washcoat dispersion coating process, and most preferably, also during the drying processes. Further, these temperatures are reproducible so that uniformity is achieved when mass producing coated support bodies.

In particular, it is preferred that the difference between the washcoat dispersion temperature and the temperature of the support body 1 is less than 10° Kelvin during the coating process. It is more preferable that the difference between the temperature of the washcoat and the temperature of the support body 1 is less than 5° Kelvin, and most preferred that the temperatures are equal. The generally equal temperature of washcoat dispersion and the support body 1 results in an equal flow behavior of the washcoat dispersion and, therefore, provides a generally uniform depth of the coating layer. Further, such a small temperature tolerance increases the consistency of the quality of the washcoat coating with regards to mass production of support bodies because the viscosity behavior of the washcoat dispersion is highly predictable.

In order to enhance the integrity and safety of the coating process, it is preferable that the dispersion temperature and/or temperature of the support body 1 are continuously monitored and regulated during the coating process. Standard contact or non-contact sensors such as heat elements, resistance sensors, and optical sensors are suitable for monitoring the temperatures of the washcoat and the support body 1. In order to maintain the desired temperatures, the washcoat dispersion and/or support body 1 may be heated, for example. A heater may be used to heat the washcoat dispersion storage container and an electrical heater, such as a radiant heater, may be used to increase the temperature of the support body 1. It is possible to adjust the different coating characteristics along the support body 1 by predetermining and controlling the temperature profiles of the support body 1 and washcoat.

Preferably, the reproducible and controllable temperature conditions for the support body 1 are also maintained, if necessary, during the impregnation, calcification, and/or storage of the support body 1. Normally, the excess washcoat dispersion is removed from the support body 1 after the coating process, and the support body 1 is then air-dried for about an hour at about 250° Celsius. During this time, the washcoat dispersion hardens to form a washcoat layer. Usually, the coated support body is then impregnated with a watery platinum and/or rhodium nitrate and dried for about three hours at approximately 300 degrees Celsius. Thereafter, a calcification occurs for about three hours at about 600 degrees Celsius. In conclusion the catalysts are, for example, reduced in a hydrogen current at about 600 degrees Celsius for about two hours.

A support body 1 coated with a washcoat in accordance with the present invention is shown in FIG. 2. The support body 1 includes partitions 2 that are produced, at least partially, of a structured metal foil. The flow channels 3 are coated with the washcoat dispersion 6. The washcoat 6 consists of a heavily craggy surface in which catalysts are arranged. This arrangement supports the conversion of harmful chemicals in exhaust fumes when the support body 1 is used in an exhaust fume system of an automobile combustion engine. During the process of coating the support body 1, controllable or reproducible conditions exist with regards to the washcoat dispersion temperature and the temperature of the support body 1. Therefore, a uniform layer depth 8 of the washcoat 6 in the flow channels 3 is produced. The depth of the layer 8 is, preferably, between 10 and 30 μm, especially at partitions 2 having a thickness 7 smaller than 0.03 mm. However, the depth of the coating layer 8 is, among other things, also dependent on the free cross-section of the flow channels 3 and has to be adjusted accordingly.

The inventive method described above for coating support bodies with washcoat wherein the dispersion temperature corresponds with the temperature of the support body at least during the coating process provides reproducible layer depths of the washcoat onto the partitions of the support body flow channels. Therefore, a predictable and uniform flow behavior of the gas flow passing through the support body occurs.

Certain modifications and improvements will occur to those skilled in the art upon a reading of the foregoing description. All such modifications and improvements of the present invention have been deleted herein for the sake of conciseness and readability but are properly within the scope of the following claims.

What is claimed is:

1. A method of applying a washcoat dispersion coating to a support body comprising the steps of:
controlling the temperature of the support body;
controlling the temperature of the washcoat dispersion coating; and
applying the washcoat dispersion coating to the support body while controlling the temperature of the support body and controlling the temperature of the washcoat dispersion.

2. The method of claim 1 further comprising the step of drying the washcoat dispersion on the support body while controlling the temperature of the support body and controlling the temperature of the washcoat dispersion.

3. The method of claim 1 further comprising the step of impregnating the washcoat dispersion on the support body while controlling the temperature of the support body and controlling the temperature of the washcoat dispersion.

4. The method of claim 1 further comprising the step of calcificating the washcoat dispersion on the support body while controlling the temperature of the support body and controlling the temperature of the washcoat dispersion.

5. The method of claim 1 further comprising the step of storing the support body while controlling the temperature of the support body and controlling the temperature of the washcoat dispersion.

6. The method of claim 1 wherein the difference between the temperature of the support body and the temperature of the washcoat dispersion is no greater than 10° K.

7. The method of claim 6 wherein the difference between the temperature of the support body and the temperature of the washcoat dispersion is no greater than 5° K.

8. The method of claim 7 wherein the temperature of the support body and the temperature of the washcoat dispersion are substantially equal.

9. The method of claim 1 further comprising the steps setting a desired temperature for the support body and setting a desired temperature for the washcoat dispersion.

10. The method of claim 9 further comprising the steps of:
ascertaining the temperature of the support body and the temperature of the dispersion during the applying step; and
adjusting the temperature of the supply body and the temperature of the dispersion to achieve the desired temperature for the support body and the desired temperature for the washcoat dispersion based on the ascertaining step.
